(19) United States
(12) Patent Application Publication
(10) Pub. No.: US 2023/0036149 A1
(43) Pub. Date: Feb. 2, 2023

(54) SANITARY SLEEVE FOR A HANDHELD ITEM

(71) Applicants: BIC VIOLEX SINGLE MEMBER S.A., ANOIXI (GR); SOCIÉTÉ BIC, Clichy Cedex (FR)

(72) Inventors: Eirini PETRATOU, Anoixi (GR); Dimitrios KLIMANOGLOU, Anoixi (GR)

(73) Assignees: BIC VIOLEX SINGLE MEMBER S.A., ANOIXI (GR); SOCIÉTÉ BIC, Clichy Cedex (FR)

(21) Appl. No.: 17/870,049

(22) Filed: Jul. 21, 2022

(30) Foreign Application Priority Data
Jul. 30, 2021 (EP) 21188865.6

(51) Int. Cl. B25G 1/10; B43K 29/00; B43K 23/00

(52) U.S. Cl. CPC B25G 1/10; B43K 29/00; B43K 23/00

(57) ABSTRACT

A sanitary sleeve comprising a body configured to be grasped by a hand of a user, the body extending from a first end toward a second end along an axis, the body including a plurality of layers configured to be removed one at a time, and the plurality of layers including at least a first layer and a second layer, and wherein removal of the first layer of the plurality of layers exposes the second layer of the plurality of layers.

### CROSS REFERENCE TO RELATED APPLICATION(S)

This application claims priority from European patent application EP21188865.6, filed on Jul. 30, 2021, the entire contents of which being incorporated herein by reference.

### FIELD

The present disclosure relates generally to the field of sanitization. Particularly, the present disclosure relates to a sanitary device configured for use on a handheld item. More specifically, the present disclosure relates to a sanitary device configured for use on a stationary item, such as a writing instrument.

### BACKGROUND

Contagious diseases, such as the flu, colds, strep throat, viruses and the like are often transmitted from an infected person to another person directly and indirectly. For example, a contagious disease may be transmitted directly from person to person via respiration when people are physically dose and inhale droplets and particles that infected people release as they breathe, talk, cough, sneeze, sing, and the like. Additionally, a contagious disease may be transmitted indirectly when a person touches a contaminated surface or object before touching their own mouth, nose, and/or eyes.

Handheld items, particularly stationary items, such as a writing instrument, are often used and shared by several people and/or placed on various surfaces in a given area. A person using the stationary item, and the various surfaces in which the stationary item is placed, may be infected and/or contaminated, respectively. As such, a stationary item may become a vehicle for direct and/or indirect transmission of a contagious disease.

Traditional solutions may include applying a sanitizing gel or spray directly to a stationary item, which results in a messy, slippery, and/or overall unpleasant experience for a user. Additionally, application of the sanitizing gel or spray directly to the stationary item may be inconsistent, as sanitizing gel or spray may be unavailable or areas of the stationary item may be missed, Further, because the surface of a stationary item has not changed after being sanitized, a user may be led to believe that the stationary item is still unsanitary.

It is desirable to provide a sanitary device configured for use on a handheld item, which allows a user to sanitize the handheld item by changing and/or removing a potentially contaminated surface of the handheld item, without direct application of gels or sprays to the handheld item, in a hassle-free and convenient manner.

### SUMMARY

According to aspects of the present disclosure, a sanitary sleeve configured for use on a stationary item is provided. The sanitary sleeve comprises a body configured to be grasped by a hand of a user, the body extending from a first end toward a second end along an axis, the body including a plurality of layers configured to be removed or peeled off one at a time, and the plurality of layers including at least a first layer and a second layer, and wherein removal of the first layer of the plurality of layers exposes the second layer of the plurality of layers.

According to aspects of the present disclosure, each layer of the plurality of layers is wrapped against one or more layer of the plurality of layers in a surface-to-surface relationship.

According to aspects of the present disclosure, each layer of the plurality of layers is wrapped radially about the axis.

According to aspects of the present disclosure, each layer of the plurality of layers is elastically deformable.

According to aspects of the present disclosure, the first end of the body defines an entry opening configured for the stationary item to extend through.

According to aspects of the present disclosure, the body is configured to define a space extending from the first end of the body toward the second end of the body and the space is configured to receive the stationary item.

According to aspects of the present disclosure, the second end of the body defines an exit opening configured to allow the stationary item to protrude out of the body.

According to aspects of the present disclosure, an applicator tube is configured to be positioned within the space defined by the body, and the applicator tube is configured to receive the stationary item.

According to aspects of the present disclosure, the applicator tube is elastically deformable.

According to aspects of the present disclosure, each layer of the plurality of layers has a thickness within a range of 10 μm to 100 μm.

According to aspects of the present disclosure, each layer of the plurality of layers includes a pull tab configured to be pulled by the user.

According to aspects of the present disclosure, each layer of the plurality of layers includes a sanitary agent configured to sanitize the hand of the user.

According to aspects of the present disclosure, a stationary item is provided. The stationary item comprises a housing and the sanitary sleeve according to any aspect disclosed herein surrounding the housing of the stationary item.

According to aspects of the present disclosure, a method of sanitizing a stationary item is provided. The method comprises providing the sanitary sleeve according to any aspect disclosed herein and removing the first layer of the plurality of layers of the body.

According to aspects of the present disclosure, removing the first layer of the plurality of layers includes pulling the first layer of the plurality of layers away from the second layer of the plurality of layers.

In the manner described and according to aspects illustrated herein, the sanitary sleeve, the stationary item, and the method for sanitizing a stationary item allows a user to sanitize the stationary item by changing and/or removing and/or peeling away a potentially contaminated surface of the stationary item, without direct application of gels or sprays to the stationary item, in a hassle-free and convenient manner.

### BRIEF DESCRIPTION OF THE DRAWINGS

Aspects of an embodiment will be described in reference to the drawings, where like numerals reflect like elements:

FIG. 1 is a perspective view of a sanitary sleeve, included on a writing instrument, according to aspects of the disclosure;

FIG. 2 is a perspective view of the sanitary sleeve according to FIG. 1;

FIG. 3 is a cross-sectional view of the sanitary sleeve according to FIG. 1, taken along an axis A-A;

FIG. 4 is a top view of the sanitary sleeve according to FIG. 1;

FIG. 5 is a perspective view of the sanitary sleeve according to FIG. 1, including an applicator tube according to aspects of the disclosure;

FIG. 6 is a cross-sectional view of the sanitary sleeve and the applicator tube according to FIG. 5, taken along the axis A-A;

FIG. 7 is a perspective view of the sanitary sleeve according to FIG. 1, illustrating removal of a first layer of the sanitary sleeve by a user according to aspects of the disclosure;

FIG. 8 is a perspective view of the sanitary sleeve according to FIG. 1, included on a glue stick according to aspects of the disclosure; and

FIG. 9 is a perspective view of the sanitary sleeve according to FIG. 1, illustrating an alternative arrangement of a plurality of layers of the sanitary sleeve according to aspects of the disclosure.

### DETAILED DESCRIPTION

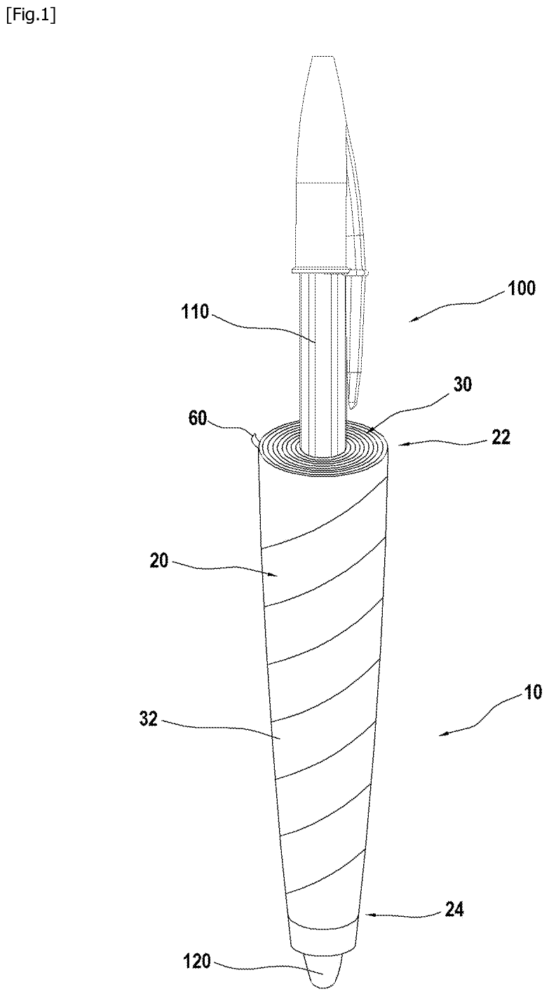

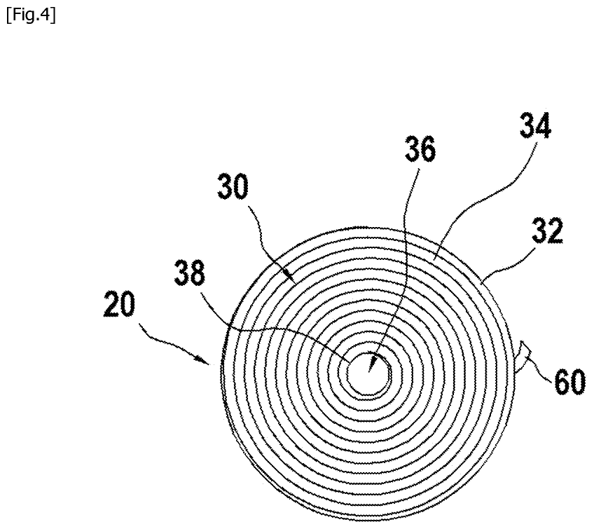

An embodiment of a sanitary sleeve also referred to herein as a “sanitary device” configured for use on a stationary item, a stationary item, and a method of sanitizing a stationary item according to aspects of the disclosure will now be described with reference to FIGS. 1-9. Like numerals represent like parts, and the sanitary sleeve will generally be referred to by the reference numeral 10. Although the sanitary sleeve 10 is described with reference to specific examples, it should be understood that modifications and changes may be made to these examples without going beyond the general scope as defined by the claims. In particular, individual characteristics of the various embodiments shown and/or mentioned herein may be combined in additional embodiments. Consequently, the description and the drawings should be considered in a sense that is illustrative rather than restrictive. The Figures, which are not necessarily to scale, depict illustrative aspects and are not intended to limit the scope of the disclosure. The illustrative aspects depicted are intended only as exemplary.

The term “exemplary” is used in the sense of “example,” rather than “ideal.” While aspects of the disclosure are amenable to various modifications and alternative forms, specifics thereof have been shown by way of example in the drawings and will be described in detail. It should be understood, however, that the intention is not to limit aspects of the disclosure to the particular embodiment(s) described. On the contrary, the intention of this disclosure is to cover all modifications, equivalents, and alternatives falling within the scope of the disclosure.

Various materials, methods of construction and methods of fastening will be discussed in the context of the disclosed embodiment(s). Those skilled in the art will recognize known substitutes for the materials, construction methods, and fastening methods, all of which are contemplated as compatible with the disclosed embodiment(s) and are intended to be encompassed by the appended claims.

As used in this disclosure and the appended claims, the singular forms “a,” “an,” and “the” include plural referents unless the content clearly dictates otherwise. As used in this disclosure and the appended claims, the term “or” is generally employed in its sense including “and/or” unless the content clearly dictates otherwise.

Throughout the description, including the claims, the terms “comprising a,” “including a,” and “having a” should be understood as being synonymous with “comprising one or more,” “including one or more,” and “having one or more” unless otherwise stated. In addition, any range set forth in the description, including the claims should be understood as including its end value(s) unless otherwise stated. Specific values for described elements should be understood to be within accepted manufacturing or industry tolerances known to one of skill in the art, and any use of the terms “substantially,” “approximately,” and “generally” should be understood to mean falling within such accepted tolerances.

When an element or feature is referred to herein as being “on,” “engaged to,” “connected to,” or “coupled to” another element or feature, it may be directly on, engaged, connected, or coupled to the other element or feature, or intervening elements or features may be present. In contrast, when an element or feature is referred to as being “directly on,” “directly engaged to,” “directly connected to,” or “directly coupled to” another element or feature, there may be no intervening elements or features present. Other words used to describe the relationship between elements or features should be interpreted in a like fashion (e.g., “between” versus “directly between,” “adjacent” versus “directly adjacent,” etc.).

Spatially relative terms, such as “top,” “bottom,” “middle,” “inner,” “outer,” “beneath,” “below,” “lower,” “above,” “upper,” and the like, may be used herein for ease of description to describe one element or feature's relationship to another element(s) or feature(s) as illustrated in the drawings. Spatially relative terms may be intended to encompass different orientations of a device in use or operation in addition to the orientation depicted in the drawings. For example, if the device in the drawings is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Although the terms “first,” “second,” etc. may be used herein to describe various elements, components, regions, layers, sections, and/or parameters, these elements, components, regions, layers, sections, and/or parameters should not be limited by these terms. These terms are only used to distinguish one element, component, region, layer, or section from another region, layer, or section. Thus, a first element, component, region, layer, or section discussed herein could be termed a second element, component, region, layer, or section without departing from the teachings of the present disclosure.

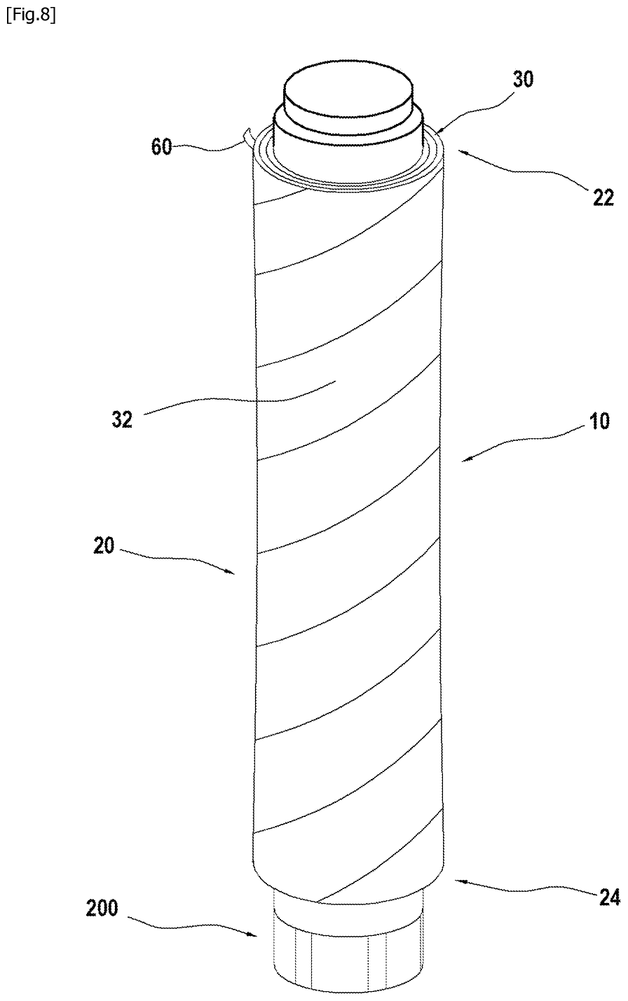

As shown in FIGS. 1 and 8, the sanitary sleeve 10 is configured for use on a handheld item. In particular, the sanitary sleeve 10 is configured for use on a stationary and/or craft item, such as a writing instrument (see FIG. 1), a paintbrush, a glue stick 130 (see FIG. 8), a paper cutter, an eraser, a protractor, and the like. Specifically, in the disclosed embodiment, the sanitary sleeve 10 is configured for use on a writing instrument 100. Additionally or alternatively, it is contemplated that the sanitary sleeve 10 may be part of the writing instrument 100. Accordingly, the sanitary sleeve 10 will be discussed herein as being configured for use on and/or a part of the writing instrument 100, however, it should be understood that other uses may be possible. It is contemplated that the term “writing instrument” may be understood herein as a pen, pencil, mechanical pencil, marker, highlighter, and/or any other tool capable of being used to produce writing and/or drawing (e.g. figures, characters, lines, forms, and/or the like) upon a surface. Additionally, as shown in FIG. 1, the writing instrument 100 may include a cylindrical housing 110 (constructed of plastic, metal, wood, and/or the like) configured to be grasped by a hand of a user and to surround a writing medium (such as ink, graphite, and/or the like) (not shown) and a writing tip and/or nib 120 configured to transfer the writing medium to a surface.

As shown in FIGS. 1-3 and 5-9, the sanitary sleeve 10 includes a body 20 that extends from a first end 22 toward a second end 24 along an axis A-A. Additionally, the body extends radially outwardly from the axis A-A, between the first end 22 of the body 20 and the second end 24 of the body 20. It is contemplated that the terms “outwardly” and/or “outer” as used herein may be understood to mean a direction away the axis A-A and the terms “inwardly” and/or “inward” as used herein may be understood to mean a direction toward the axis A-A. The body 20 may be configured to include a contour having an ergonomic design so that the sanitary sleeve 10 is comfortable to the user, when grasped by the hand of the user.

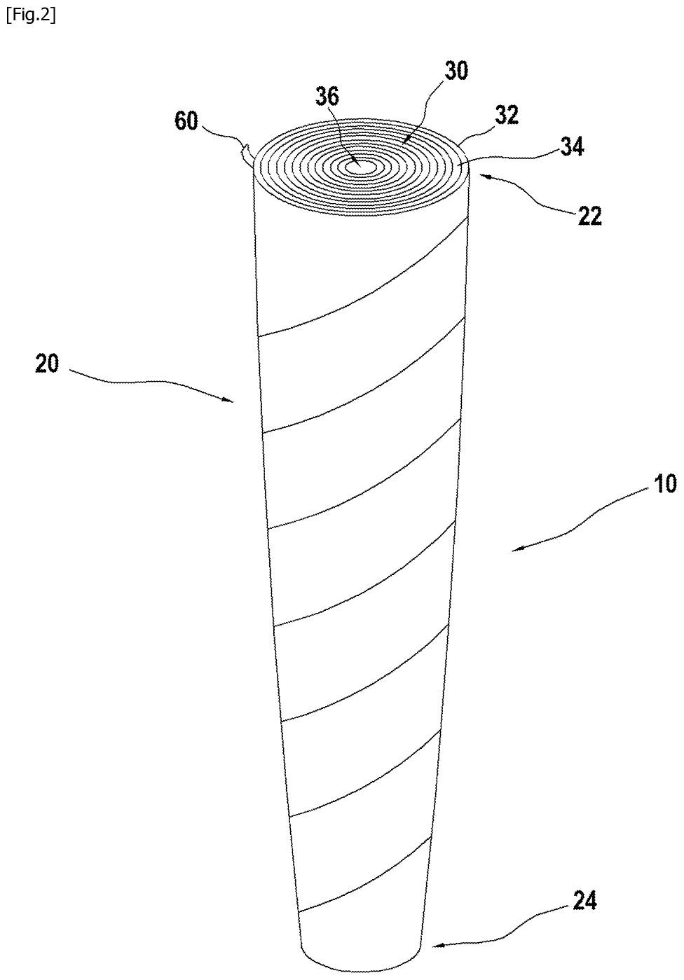

As shown in FIGS. 2-9, the body 20 includes a plurality of layers 30. As such, the plurality of layers 30 includes at least a first layer 32 of the body 20 and a second layer 34 of the body 20. In the disclosed embodiment, the first layer 32 is a layer of the plurality of layers 30 that is an outermost layer of the plurality of layers 30. Accordingly, the first layer 32 of the plurality of layers 30 is a layer of the body 20 that is capable of coming into contact with and/or being grasped by the hand of the user. In the disclosed embodiment, the second layer 34 is a layer of the plurality of layers 30 that is directly inward and/or beneath the first layer 32 of the plurality of layers 30. In the disclosed embodiment, the first layer 32 of the plurality of layers 30 may be contiguous with the second layer 34 of the plurality of layers 30. Additionally, the first layer 32 may fully cover the second layer 34 and/or remaining layers of the plurality of layers 30.

In the disclosed embodiment, the body 20 may include an amount of layers 30 within a range of 5 to 150, particularly the body 20 may include 100 layers. Each layer of the plurality of layers 30 includes substantially the same construction. In the disclosed embodiment, each layer of the plurality of layers 30 is constructed as a film (also may be referred to herein as a “membrane”). Particularly, each layer of the plurality of layers 30 may be configured as a thin film. To this end, each layer of the plurality of layers 30 may be constructed to have a thickness within a range of 10 μm to 100 μm, particularly each layer may have a thickness of 20 μm. However, in examples, it is contemplated that layers 30 having different thicknesses may also be possible. Configuring each layer of the plurality of layers 30 as a thin film allows the body 20 to include a sufficient amount of layers without substantially altering and/or distorting a shape and/or contour of the writing instrument 100. For example, the body 20 including 100 layers having a thickness of 20 μm increases a thickness of the writing instrument 100 by 2 mm. Accordingly, a feel of the writing instrument 100 including the sanitary sleeve 10 within the hand of the user is not substantially altered and/or distorted, in contrast with a feel of the writing instrument 100 without the sanitary sleeve 10 within the hand of the user. Additionally, each layer of the plurality of layers 30 may be configured to be elastically deformable. Additionally, each layer of the plurality of layers 30 may be configured to be substantially impermeable. To this end, each layer of the plurality of layers 30 may be constructed of an elastically deformable and/or substantially impermeable material, such as polyethylene (PE), polypropylene (PP), polyethylene terephthalate (PET), and/or the like. Additionally or alternatively, each layer of the plurality of layers 30 may be thermoformable. Including layers 30 of the body 20 that are configured to be elastically deformable allows the sanitary sleeve 10 to expand and contract to fit and/or be secured onto housings 110 of writing instruments 100 of multiple sizes and/or shapes. Additionally, including layers 30 of the body 20 that are configured to be elastically deformable allows each layer of the plurality of layers 30 to be easily peeled away from the body 20 and/or the remaining layers of the plurality of layers 30. Including layers 30 of the body 20 that are configured to be substantially impermeable reduces a probability that a harmful pathogen is able to pass from one layer of the plurality of layers 30 to another, such as from the first layer 32 of the plurality of layers 30 to the second layer 34 of the plurality of layers 30. Additionally, each layer of the plurality of layers 30 may be configured to sanitize the hand of the user. To this end, each layer of the plurality of layers 30 may include a sanitizing agent. In particular, the sanitizing agent may include silver, copper, zinc pyrithione, selenium, quaternary ammonium, and/or any other substance capable of sanitizing the hand of the user. Including layers 30 that are configured to sanitize the hand of the user helps to reduce the transmission of contagious disease by eliminating harmful pathogens that may be present on the hand of the user. Additionally, including layers 30 of the body 20 that are configured to sanitize the hand of the user allows the sanitizing agent to be applied to the writing instrument 100, without the user having to directly apply gels or sprays to the writing instrument 100, thereby improving consistency and convenience of the application of the sanitizing agent to the writing instrument 100.

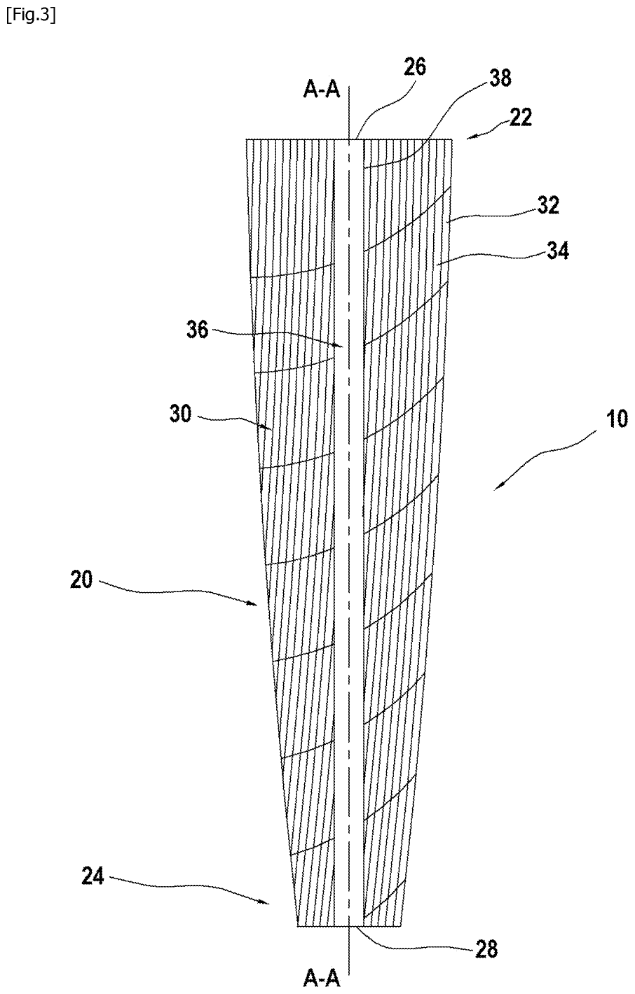

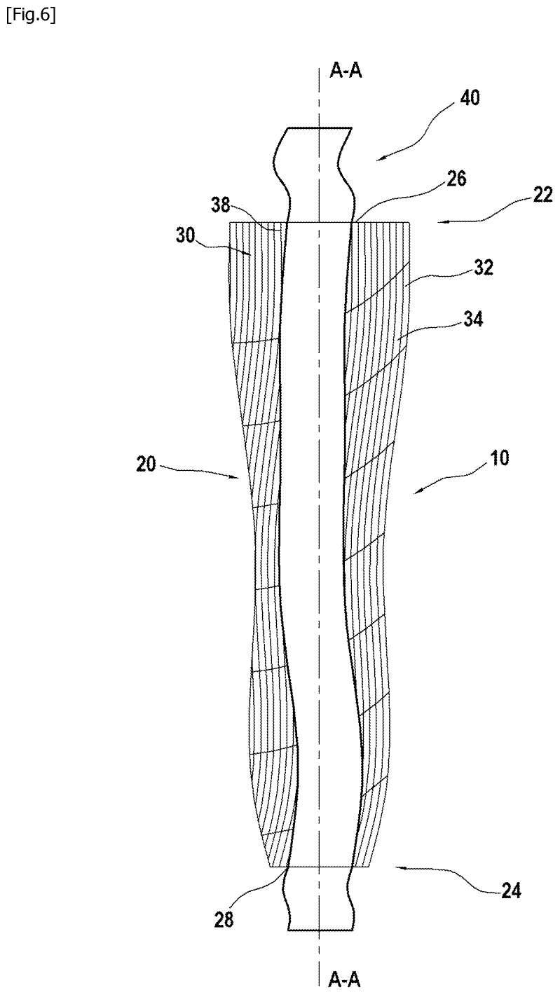

As shown in FIG. 1, the sanitary sleeve 10 is configured to receive and/or surround the writing instrument 100, so that the sanitary sleeve 10 is secured to the writing instrument 100. To this end, as shown in FIGS. 3 and 6, the body 20 is configured to define a space 36 extending from the first end 22 of the body 20 to the second end 24 of the body 20. The space 36 defined by the body 20 is configured to receive and/or surround the writing instrument 100. Additionally, the body 20 is configured to define a first opening (also referred to herein as an “entry opening”) 26 at the first end 22 of the body 20 and a second opening (also referred to herein as an “exit opening”) 28 at the second end 24 of the body 20. Each of the first opening 26 and the second opening 28 defined by the body 20 are in communication with the space 36 defined by the body 20. In this manner, the first opening 26 defined by the body 20 is configured to allow the writing instrument 100 to extend into the space 36 defined by the body 20. Additionally, the second opening 28 defined by the body 20 is configured to allow the writing instrument 100 to protrude out of the body 20. Accordingly, the writing instrument 100 may be inserted through the first opening 26 defined by the body 20 and pushed through the space 36 defined by the body 20, so that the nib 120 of the writing instrument 100 protrudes out of the second opening 28 defined by the body 20. In this manner, the sanitary sleeve 10 surrounds the housing of the writing instrument 100, while the nib 120 is exposed and/or free to transfer the writing medium to a surface.

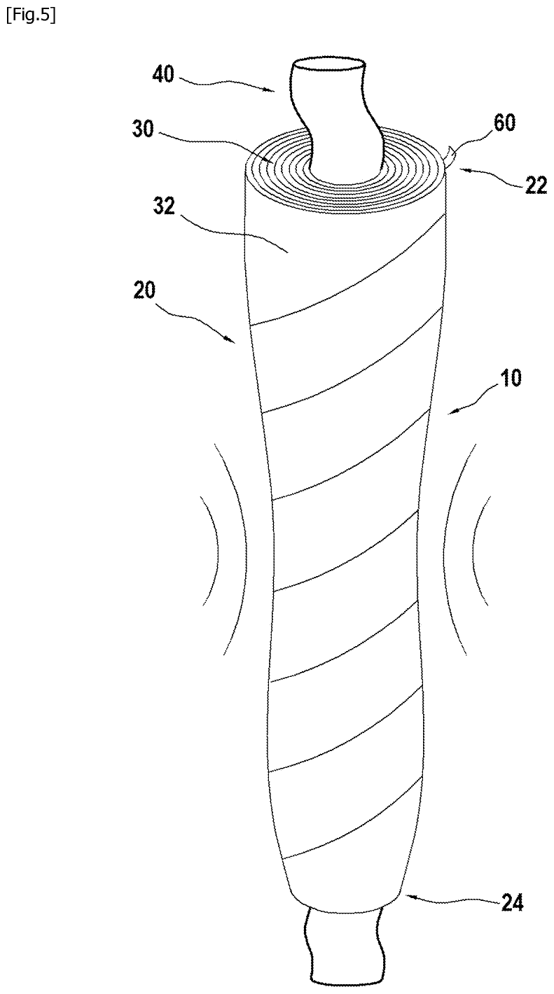

As shown in FIG. 1, the body 20 of the sanitary sleeve 10 may directly receive and/or surround the writing instrument 100, such that the plurality of layers 30 are wrapped against the housing 110 of the writing instrument 100. In examples, as shown in FIGS. 5-6, the space 36 defined by the body 20 may be configured to receive an applicator tube 40. The applicator tube 40 may be configured to extend between the first end 22 of the body 20 and the second end 24 of the body 20. Additionally, the applicator tube 40 is configured to receive and/or surround the writing instrument 100, thereby securing the body 20 of the sanitary sleeve 10 to the writing instrument 100. Inclusion of the applicator tube 40 within the space 36 defined by the body 20 helps to retain the shape of the body 20. Additionally, inclusion of the applicator tube 40 within the space 36 defined by the body 20 improves application and removal of the sanitary sleeve 10 to and from the writing instrument 100. Additionally or alternatively, the applicator tube 40 may be configured to be elastically deformable. To this end, the applicator tube 40 may be constructed of an elastically deformable material, such as rubber. Including an applicator tube 40 that is configured to be elastically deformable within the space 36 defined by the body 20 allows the sanitary sleeve 10 to fit and/or be secured onto housings 110 of writing instruments 100 of multiple sizes. In examples, it is contemplated that the plurality of layers 30 may be each wrapped and/or wound onto the housing of the writing instrument 100, as opposed to the writing instrument 100 being inserted into a fully-assembled body 20 of the sanitary sleeve 10.

As shown in FIGS. 3-4 and 6, each layer of the plurality of layers 30 is configured to be wrapped against one or more layer contiguously in a surface-to-surface relationship. For example, the first layer 32 of the plurality of layers 30 is only wrapped against the second layer 34 of the plurality of layers 30. However, the second layer 34 of the plurality of layers 30 is wrapped against and/or sandwiched between the first layer 32 of the plurality of layers 30 and a layer of the plurality of layers 30 directly inward and/or beneath the second layer 34 of the plurality of layers 30. Additionally, one or more layer of the plurality of layers 30 that are inward and/or beneath the second layer 34 of the plurality of layers 30 may be wrapped against and/or sandwiched between the second layer 34 and/or other layers of the plurality of layers 30. Additionally, an innermost layer 38 of the plurality of layers 30 is wrapped against and/or sandwiched between a layer of the plurality of layers 30 directly outward of the innermost layer 38 and the applicator tube 40 and/or the writing instrument 100.

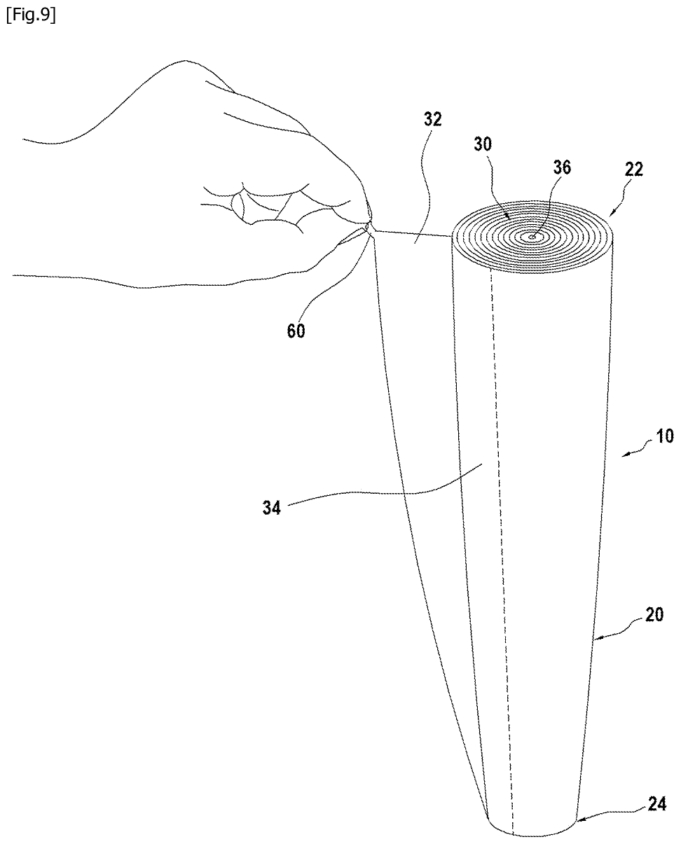

In the disclosed embodiment, the plurality of layers 30 are wrapped against each other radially about the axis A-A. Additionally, the plurality of layers 30 are wrapped against each other such that the body 20 of the sanitary sleeve 10 is configured to be cylindrical in shape. To this end, as shown in FIGS. 1-2, 5, and 7-8, each layer of the plurality of layers 30 may be wrapped about the axis A-A in a helical arrangement. In this arrangement, each layer of the plurality of layers 30 includes edges that extend about the axis A-A helically. In examples, as shown in FIG. 9, each layer of the plurality of layers 30 may be wrapped about the axis A-A such that each layer of the plurality of layers 30 includes edges that extend about the axis A-A axially. Configuring the body 20 to be cylindrical in shape allows a shape of the sanitary sleeve 10 to be consistent with a shape of the writing instrument 100, so as to not alter and/or distort the feel of the writing instrument 100 within the hand of the user. An inner side of each layer of the plurality of layers 30 may be configured to be adhesive. To this end, the inner side of each layer may include an adhesive substance, such as glue and/or any substance sufficient to maintain a bond between materials. Configuring the inner side of each layer of the plurality of layers 30 to be adhesive helps to hold the plurality of layers 30 together and/or maintain the form of the body 20. Additionally, each layer of the plurality of layers 30 may be configured as an individual layer that is separate from the other layers of the plurality of layers 30. Configuring each layer of the plurality of layers 30 as an individual, separate layer improves the removability of each layer of the plurality of layers 30 from the body 20. In examples, each layer of the plurality of layers 30 may be configured to be connected to one or more layer of the plurality of layers 30. To this end, each layer may include one or more perforation (see FIG. 9) between one or more layer of the plurality of layers 30, such that the each layer of the plurality of layers 30 is connected to one or more layer of the plurality of layers 30, and such that each layer of the plurality of layers 30 maintains removability from an adjoining layer of the plurality of layers 30 and/or the body 20. Configuring each layer of the plurality of layers 30 to be connected to one or more layers of the plurality of layers 30 improves ease and/or cost of manufacturing of the sanitary sleeve 10.

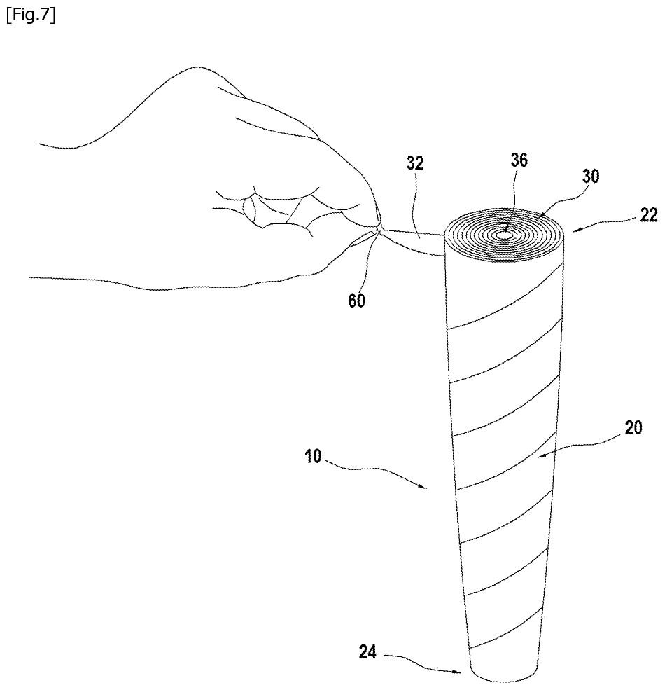

As shown in FIG. 7, each layer of the plurality of layers 30 is configured to be removed or peeled away one at a time from the body 20 and/or the remaining layers of the plurality of layers 30 of the body 20. In the disclosed embodiment, the plurality of layers 30 are configured to be removed one at a time. As shown in FIGS. 7 and 9, for removal from the body 20, the first layer 32 of the plurality of layers 30 is pulled outwardly by the user, in a direction away from the axis A-A. Alternatively stated, for removal from the body 20, the first layer 32 of the plurality of layers 30 is pulled outwardly by the user, in a direction away from the second layer 34. It should be understood that the terms “first layer” and “second layer” are merely designations for a position of a layer of the plurality of layers 30 throughout the body 20. For example, once the first layer 32 is removed, the second layer 34 is now the outermost layer of the plurality of layers 30 and effectively becomes the first layer 32. Additionally, once the second layer 34 becomes the first layer 32, a layer of the plurality of layers 30 directly inward and/or beneath the former second layer 34 (now first layer 32) becomes the second layer 34. As shown in FIGS. 1-2, 4-5, and 7-9, each layer of the plurality of layers 30 may include a pull tab 60. The pull tab 60 is configured to be grasped by the hand of the user. Including the pull tab 60 on each layer of the plurality of layers 30 improves the ease of removal of the first layer 32 of the plurality of layers 30 by the user. Additionally, including the pull tab 60 on each layer of the plurality of layers 30 helps to ensure that the user does not touch the second layer 34 of the plurality of layers 30 when removing the first layer 32 of the plurality of layers 30, thereby maintaining the effect of sanitization of the writing instrument 100 by the sanitary sleeve 10. Removal of the first layer 32 of the plurality of layers 30 exposes the second layer 34 of the plurality of layers 30. As the second layer 34 is unused and/or has not previously been touched by the user (or a previous user), removal of the first layer 32 of the plurality of layers 30 allows the user to effectively sanitize the writing instrument 100 by changing and/or removing a surface (the first layer 32) of the writing instrument 100, which may have been contaminated by the user (or a previous user), without direct application of gels or sprays to the handheld item, thereby improving convenience.

Although the present disclosure herein has been described with reference to particular embodiments, it is to be understood that these embodiments are merely illustrative of the principles and applications of the present disclosure.

It is intended that the specification and examples be considered as exemplary only, with a true scope of the disclosure being indicated by the following claims.

Additionally, all of the disclosed features of an apparatus may be transposed, alone or in combination, to a method and vice versa.

1. A sanitary sleeve configured for use on a stationary item, the sanitary sleeve comprising:
a body configured to be grasped by a hand of a user, the body extending from a first end toward a second end along an axis, the body including a plurality of layers configured to be removed one at a time, and the plurality of layers including at least a first layer and a second layer; and
wherein removal of the first layer of the plurality of layers exposes the second layer of the plurality of layers.

2. The sanitary sleeve according to claim 1, wherein each layer of the plurality of layers is wrapped against one or more layer of the plurality of layers in a surface-to-surface relationship.

3. The sanitary sleeve according to claim 1, wherein each layer of the plurality of layers is wrapped radially about the axis.

4. The sanitary sleeve according to claim 1, wherein each layer of the plurality of layers is elastically deformable.

5. The sanitary sleeve according to claim 1, wherein the first end of the body defines an entry opening configured for the stationary item to extend through.

6. The sanitary sleeve according to claim 1, wherein the body is configured to define a space extending from the first end of the body toward the second end of the body and the space is configured to receive the stationary item.

7. The sanitary sleeve according to claim 6, wherein the second end of the body defines an exit opening configured to allow the stationary item to protrude out of the body.

8. The sanitary sleeve according to claim 6, wherein an applicator tube is configured to be positioned within the space defined by the body, and the applicator tube is configured to receive the stationary item.

9. The sanitary sleeve according to claim 8, wherein the applicator tube is elastically deformable.

10. The sanitary sleeve according to claim 1, wherein each layer of the plurality of layers has a thickness within a range of 10 μm to 100 μm.

11. The sanitary sleeve according to claim 1, wherein each layer of the plurality of layers includes a pull tab configured to be pulled by the user.

12. The sanitary sleeve according to claim 1, wherein each layer of the plurality of layers includes a sanitary agent configured to sanitize the hand of the user.

13. A stationary item comprising:
a housing; and
the sanitary sleeve according to claim 1 surrounding the housing of the stationary item.

14. A method of sanitizing a stationary item, the method comprising:
providing the sanitary sleeve according to claim 1 surrounding a housing of the stationary item; and
removing the first layer of the plurality of layers of the body.

15. The method according to claim 14, wherein removing the first layer of the plurality of layers includes pulling the first layer of the plurality of layers away from the second layer of the plurality of layers.

16. The sanitary sleeve according to claim 1 and the stationary item, wherein the stationary item is selected from the group consisting of a writing instrument, a paintbrush, a glue stick, a paper cutter, an eraser, a protractor, and the like.

17. The sanitary sleeve according to claim 1, wherein the plurality of layers includes an amount of layers within a range of 5 to 150.

18. The sanitary sleeve according to claim 12, wherein the sanitizing agent includes silver, copper, zinc pyrithione, selenium, quaternary ammonium, and/or any other substance capable of sanitizing the hand of the user.

19. The sanitary sleeve according to claim 1, wherein each layer of the plurality of layers is configured to be connected to one or more layers of the plurality of layers.

20. The sanitary sleeve according to claim 19, wherein each layer of the plurality of layers includes one or more perforation between one or more layers of the plurality of layers such that the each layer of the plurality of layers can be connected to one or more layers of the plurality of layers and such that each layer of the plurality of layers maintains removability from an adjoining layer of the plurality of layers and/or the body.
